(19) United States
(12) Patent Application Publication
(10) Pub. No.: US 2002/0181992 A1
(43) Pub. Date: Dec. 5, 2002

(54) Gasoline dispensing system and method using a single printer

(76) Inventor: Ken W. Taylor, Oakridge, NC (US)

Correspondence Address: JENKENS & GILCHRIST, PC, 1445 ROSS AVENUE, SUITE 3200, DALLAS, TX, 75202, US

(21) Appl. No.: 09/850,893

(22) Filed: May 8, 2001

Related U.S. Application Data
(62) Division of application No. 09/197,277, filed on Nov. 20, 1998, now Pat. No. 6,318,917.
(60) Provisional application No. 60/066,117, filed on Nov. 21, 1997.

(51) Int. Cl. B41J 11/32

(52) U.S. Cl. 400/611

(57) ABSTRACT

A gasoline dispensing system and method according to which gasoline is dispensed from opposite ends of a dispenser system. A printer is mounted in the dispenser system for printing a receipt for a transaction occurring at one end of the dispensing system while access is provided to the printed receipt by the customer from the one end of the dispenser system. Access to the receipt by a customer from the other end of the dispenser system is prevented.

### CROSS-REFERENCE TO RELATED APPLICATION

This application is based on provisional application Ser. No. 60/066,117 filed on Nov. 21, 1997.

### BACKGROUND OF THE INVENTION

The present invention relates to a gasoline dispensing system and method and, more particularly, to such a system and method using a single printer for printing receipts for the purchase of gasoline.

In many gasoline services stations, the customer can purchase gasoline from a gasoline dispenser directly by credit card or the like. In connection with these transactions, a receipt for the customer is printed at the dispenser and is provided to the customer when the transaction is complete. However, in service station installations in which dispensing nozzles are provided on both ends of the dispenser housing in order to service two customers at once, separate printing units are usually provided which take up considerable space and adds to the complexity of the dispensing system. Also, the individual printing units and their associated cutters are expensive which adds to the cost and complexity of the system.

### SUMMARY OF THE INVENTION

The present invention, accordingly, provides a gasoline dispensing system and method according to which a single printer can print receipts for customers dispensing gasoline from both ends of a dispenser. To this end, a printer is mounted in the dispenser unit for printing a receipt for a transaction occurring at one end of the dispensing unit while access is provided to the printed receipt by the customer from the one end of the dispenser unit. Access to the receipt by a customer from the other end of the dispenser unit is prevented.

A major advantage is thus achieved with the assembly and method of the present invention since the costs, complexity and space requirements of two printing assemblies are eliminated. Also, the printing assembly of the present application can use the bezel of a standard printing assembly with little modification. Further, the printing assembly is relatively simple in construction and durable.

### DESCRIPTION OF THE DRAWINGS

FIG. 1 is an isometric view of gasoline dispensing unit according to an embodiment of the present invention.

FIG. 2 is an isometric view of the printer module of FIG. 1.

FIG. 3 is an enlarged view of the printer module of FIG. 2 with the portions of the module housing removed.

FIGS. 4 and 5 are isometric views of the carrier of the printing assembly of FIG. 3.

FIG. 6 is an enlarged isometric end view of the printing assembly of FIG. 3.

FIGS. 7 and 9 are views similar to that of FIG. 6 but showing the carrier in a different position.

FIG. 8 is an isometric view of the track assembly of FIGS. 6 and 7, taken from the bottom thereof.

FIG. 10 is an isometric view of a printing module according to another embodiment of the present invention.

FIG. 11 is a sectional view taken along the line 11-11 of FIG. 10.

FIG. 12 is an isometric view of a dispensing unit according to another embodiment of the present invention.

FIG. 13 is a sectional view taken along the line 13-13 of FIG. 12.

### DESCRIPTION OF THE PREFERRED EMBODIMENTS

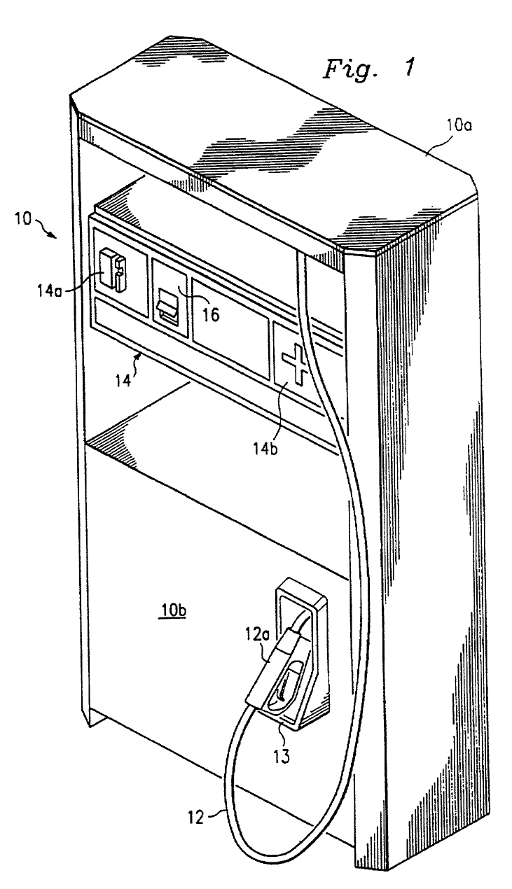

With reference to FIG. 1, the reference numeral 10 refers, in general, to a dispenser unit having an upper housing 10a and a lower housing 10b connected by two spaced support members 10c and 10d. The lower housing 10b contains hydraulics (not shown) including conduits that are connected to underground storage tanks for gasoline to be dispensed. A conduit (not shown) extends from the lower housing 10b to the upper housing 10a for passing gasoline to one end of a hose 12, the other end of which is connected to a nozzle 12a for dispensing gasoline from the storage tank to a vehicle. A boot 13 is provided on the front panel of the lower housing 10b for receiving the nozzle 12a during nonuse. An electronics housing 14 is provided in the upper housing 10a and contains various electronic components, including a credit card reader 14a and a display 14b which displays certain information relating the purchase of gasoline, as discussed above. The respective fronts of the reader 14a and the display 14b extend through the front panel, or bezel, of the housing 14.

Although not shown in the drawing, it is understood that a similar arrangement, including a hose and a nozzle, identical to the hose 12 and the nozzle 12a, are provided on the opposite, or rear, end of the dispenser unit 10, and that the electronics housing 14 also extends to this opposite end. In this manner, an additional customer can be serviced on both ends of the dispenser unit 10. Since all of this is conventional, it will not be described in further detail.

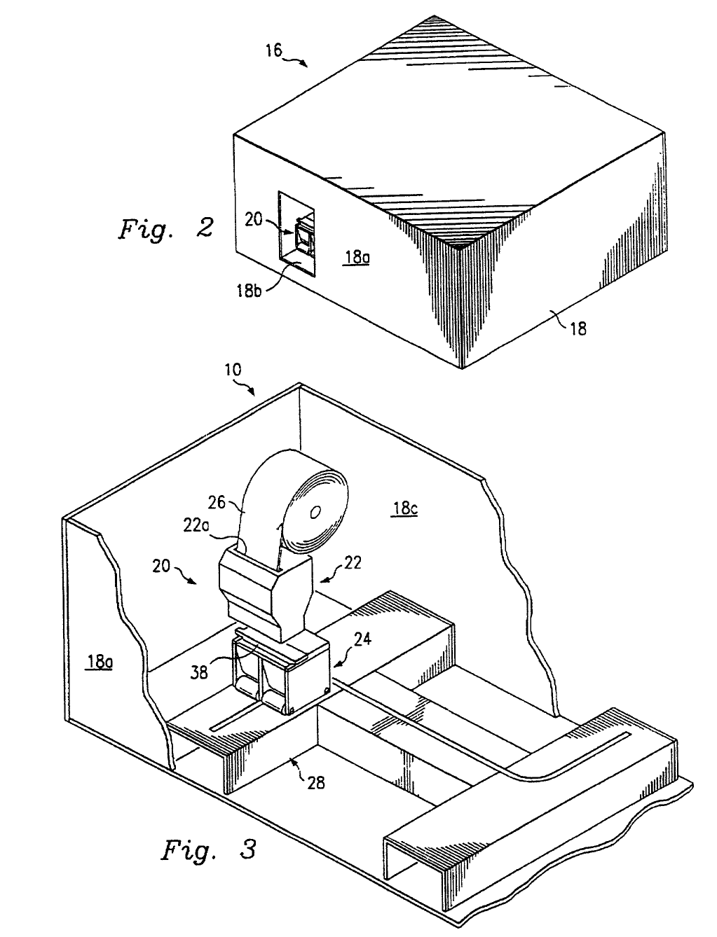

A printing module 16 is mounted in the electronic housing 14 and is shown in detail in FIGS. 2 and 3. The printing module 16 includes a cabinet 18 which extends from the front to the rear of the dispenser unit 10 and is shown only partially shown in FIG. 3 for the convenience of presentation. The cabinet 18 includes a front panel 18a flush with the front of the electronics housing 14, as viewed in FIG. 1, and has a window 18b formed therein. A door 19, shown partially lowered in FIG. 1, is provided for covering the window during nonuse of the printing module. The cabinet 18 also includes a rear panel 18c (FIG. 3) which extends flush with the rear panel (not shown) of the electronics housing 14 and it is understood that a window, identical to the window 18b extends through the rear panel 18c for servicing customers on both ends of the dispensing unit 10.

A printing assembly, shown in general by the reference numeral 20, is provided in the cabinet 18 and is shown in detail in FIG. 3. More particularly, the printing assembly 20 includes a printing head 22 mounted above a carrier 24 and adapted to receive tape 26 from a roll thereof positioned above the printing head. The printing head 22 has a slot 22a formed therein for receiving the tape 26 and is adapted to print information on the tape relating to each transaction involving dispensing gasoline from the dispenser unit 10, as described above. Since the printing head 22 is conventional it will not be described in further detail.

It is understood that the roll of tape 26 and the printing head 22 are mounted to the interior of the cabinet 18 by brackets, plates, or the like, which are not shown for the convenience of presentation, and that a motor or the like (not shown) is provided to advance the tape from the roll in a manner to allow the tape to pay out from the roll and into the slot 22a in the printing head. A track assembly 28 is provided in the cabinet 18 for guiding and supporting the carrier 24 for translational movement in the cabinet in a manner to be described.

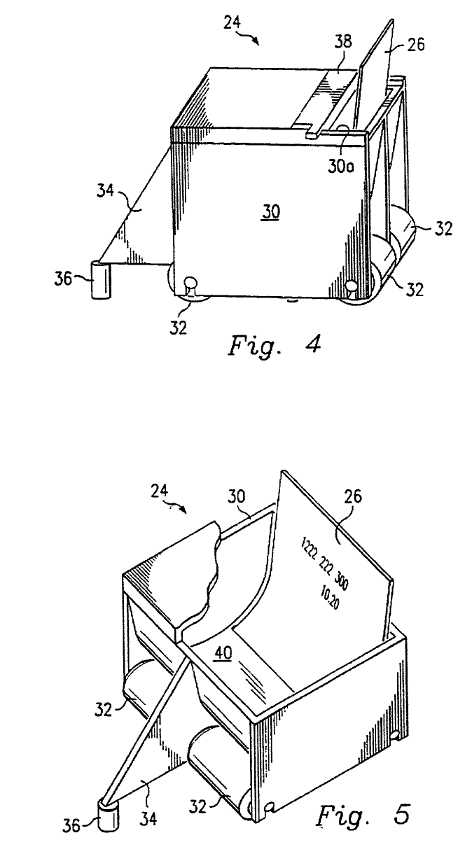

The carrier 24 is shown in detail in FIGS. 4 and 5 includes a housing 30 having two sets of two rollers 32 mounted at each end thereof. A flange 34 extends out from one end of the housing 30, and a vertically extending guide roller 36 is rotatably mounted on the end of the flange in any known manner.

A cover 38 is slidably mounted on the upper panel of the housing for movement between a retracted position shown in FIG. 4 in which it exposes a window 30a in the latter panel, and an extended position in which it covers the window. It is understood that this movement of the cover 38 can be achieved in any conventional manner such as by spring loading it to move to one position and by using a solenoid valve, or the like, (not shown) to move it to its other position. When the cover 38 is in its retracted position as shown in FIG. 4, the exposed window 30a receives the leading end section of the tape 26 from the printing head 22 under conditions to be described. A curved plate 40, shown in FIG. 5, is mounted in the housing 30 and extends from the window 30a downwardly to the bottom of the housing. The plate 40 receives a section of the tape 26 as it passes through the window and causes the leading end portion of the section to conform to the curved plate surface. The trailing end portion of the section of tape 26 projects upwardly from the housing 30 as viewed in FIG. 5.

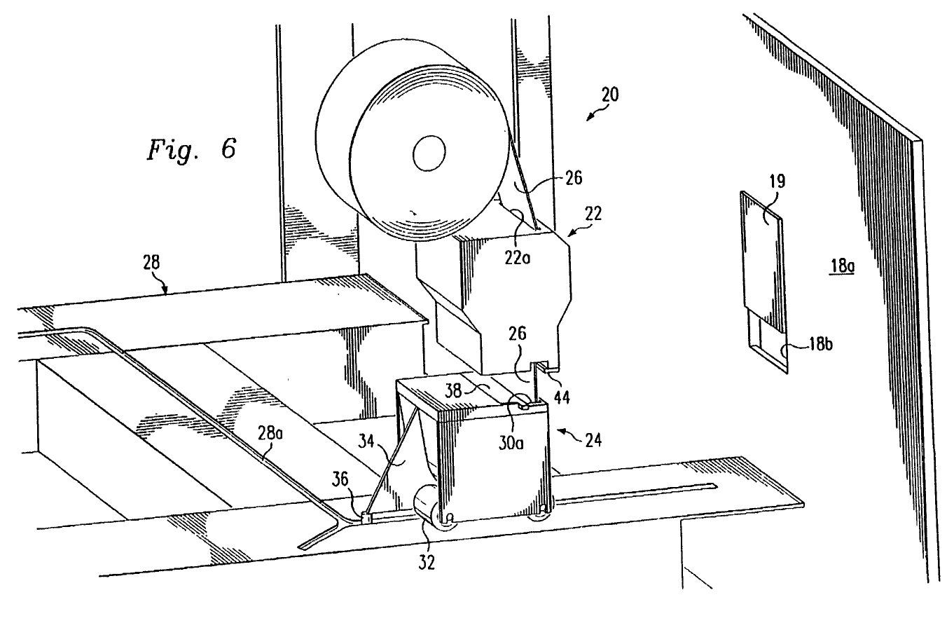

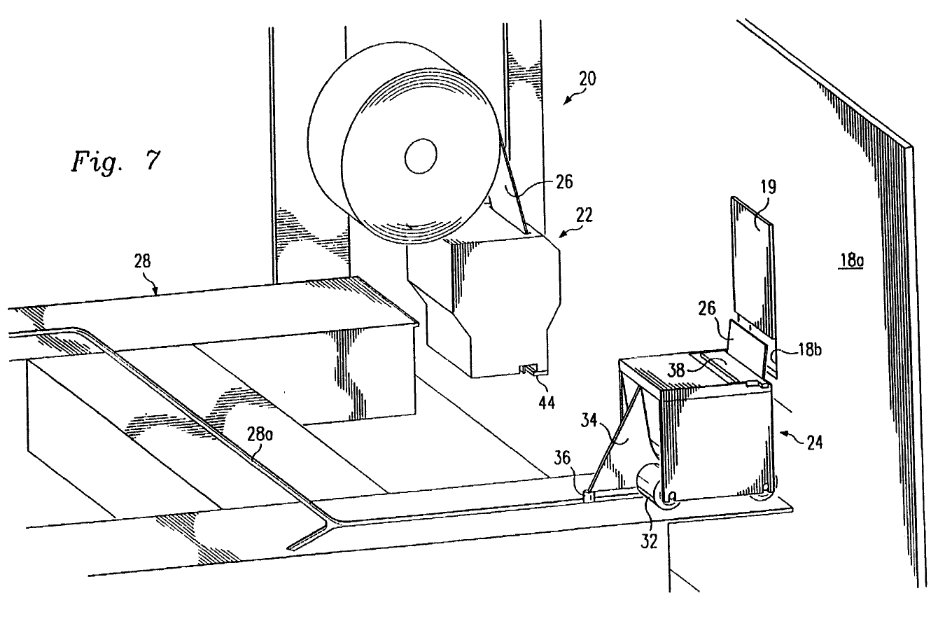

As shown in FIG. 6, a tear bar 44 is provided on the lower surface of the printing head 22 for tearing the leading end section of the tape 26 from the remaining portion thereof. When the leading end section of the tape 26 passes through the printing head 22 and into the carriage 24, the cover 38 is moved to its extended position to clamp the tape section between it and the corresponding wall of the carriage housing 30. The carriage 24 is then advanced towards the window 18b from the position shown in FIG. 6 to the position shown in FIG. 7. As a result, the portion of the tape 26 extending below the tear bar 44 is severed from the remaining portion of the tape by the tear bar. The severed section of the tape 26 forms a receipt and is ready for presentation to the customer, as will be described later.

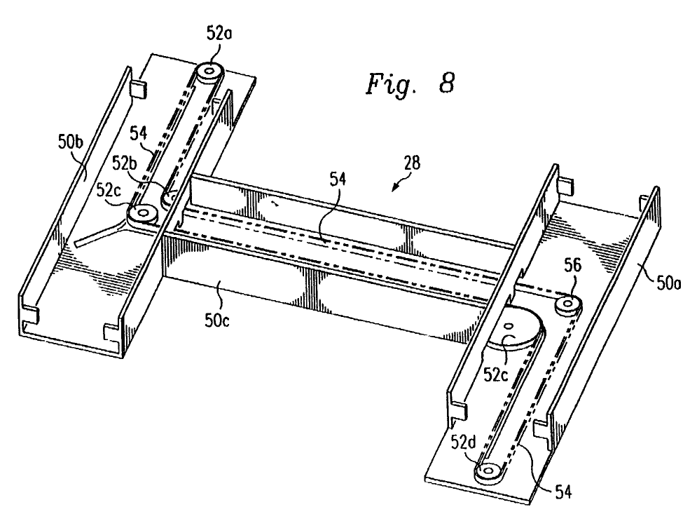

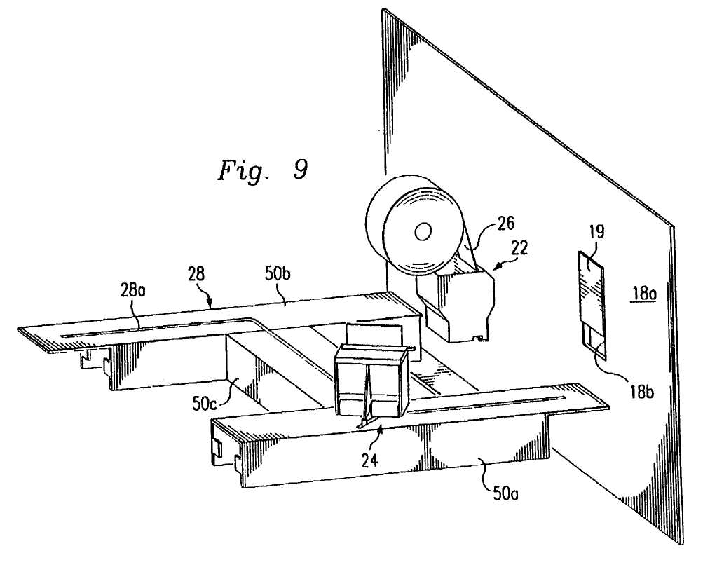

As also shown in FIGS. 6 and 7, the roller 36 extends in a slot 28a provided in the track assembly 28, to guide the movement of the carrier 24. The track assembly 28 is shown in better detail in FIGS. 8 and 9, and is formed of sheet metal formed into an approximately H-shaped pattern having two legs 50a and 50b and a center piece 50c connected to the legs and extending perpendicular to, and between, the legs.

As shown in FIG. 9, the slot 28a extends for the entire length of the center piece 50c and through a portion of the legs 50a and 50b in opposite directions. The end of the slot 28a in the leg 50a is located near the front panel 18a of the cabinet 18, and the other end of the slot 28a in the leg 50b is located near the rear panel 18c (FIG. 3) of the latter housing. Thus, the carrier 24 is adapted to deliver sections of the tape 26 to the opposite walls of the cabinet 18. An additional slot 28b is formed in the track section 50a at the intersection of the slot 28a in the latter section and in the section 50c. The slot 28b enables the carrier to reverse directions when moving from between the front wall 18a of the cabinet 18 and the rear wall thereof.

Three pulleys 52a-52c (FIG. 8) are rotatably mounted in the leg 50a of the track assembly 28 in any known manner and three pulleys 52d-52f are rotatably mounted in the leg 50b. An endless chain 54 is mounted over the pulley 52a-52f in engagement therewith and moves in a path substantially corresponding to the path formed by the slot 28a which is not shown in FIG. 8 for the convenience of presentation. It is understood that the bottom of the carrier 24 is attached to a segment of the chain 54 in any conventional manner so that the chain can drive the carrier, with the roller 36 extending in the slot 28a to provide guidance, as shown in FIG. 9. It is also understood that a motor, or the like (not shown) is provided that is connected to the chain or to one of the pulleys 52a-52e to drive the chain 54, and therefore the carrier 24, in two directions. Thus, when the motor is actuated, the carrier 24 moves to and from the printing head 22 in two directions-one towards the front panel 18a of the cabinet 18 and the other towards the rear panel. Thus, the carrier 24 can be driven along the slot 28a between positions in which a section of the tape 26 can be dispensed from both ends of the housing 10.

In operation, it will be assumed that a customer dispenses gasoline from the front of the dispenser 10, as shown in FIG. 1 and therefore uses the nozzle 12a. Upon completion of the transaction, including the purchase of the gasoline by a credit card or the like, the leading end portion of the tape 26 is passed through the printing head 22 which prints information relating to the transaction, as shown in FIG. 6. The cover 38 on the carrier 24 is in its retracted position to expose the window 30a and the printed section of the tape 26 pays out from the roll, with its leading end section passing through the window and into the housing 30 of the carrier 24. The cover 38 is then moved to its extended position to clamp a portion of the tape 36 between it and the corresponding panel of the housing 30.

The above-mentioned motor is activated to drive the chain 54 (FIG. 9) in a direction to cause the carrier 24 to advance from the position shown in FIG. 6 to the position shown in FIG. 7. This movement pulls the tape 26 over the tear bar 44 to tear off the leading end section from the remaining tape 26 which forms a receipt for the transaction. The trailing portion of the severed section extends upwardly from the housing 30 of the carrier 24. The cover 38 is then retracted and the door 19 is moved upwardly (preferably by the customer) to expose the severed section of the tape 26, which can easily be removed by the customer.

If a customer dispenses gasoline from the rear of the dispensing unit 20 where the other end panel 18c (FIG. 3) is exposed, the carrier 24 would be initially moved in the manner described above to sever the leading end section of the tape. The direction of the chain 54 would then be reversed to move the carrier 24 into the slot 28b of the track assembly as shown in FIG. 9, where it reverses directions and passes to the window in the panel 18c for receipt by the customer.

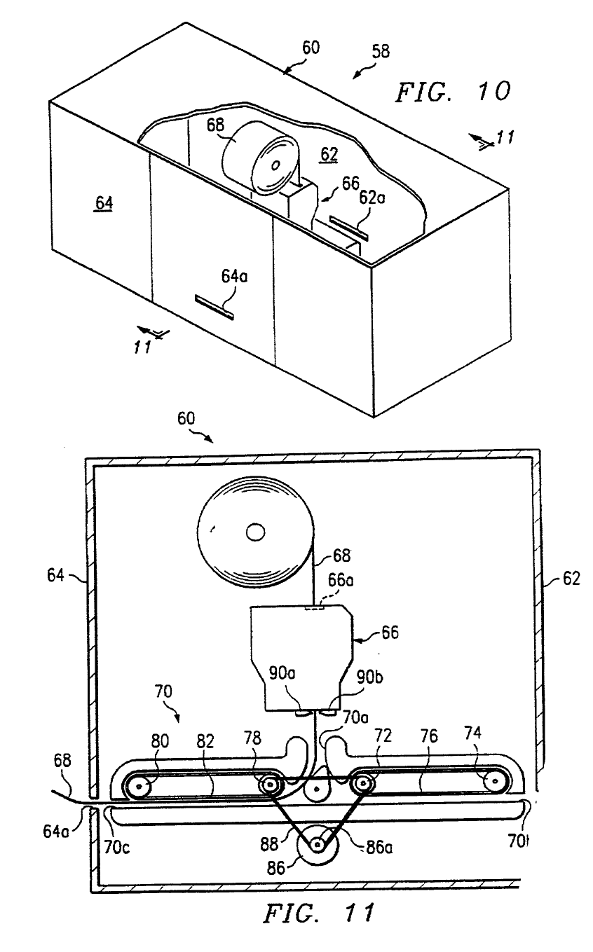

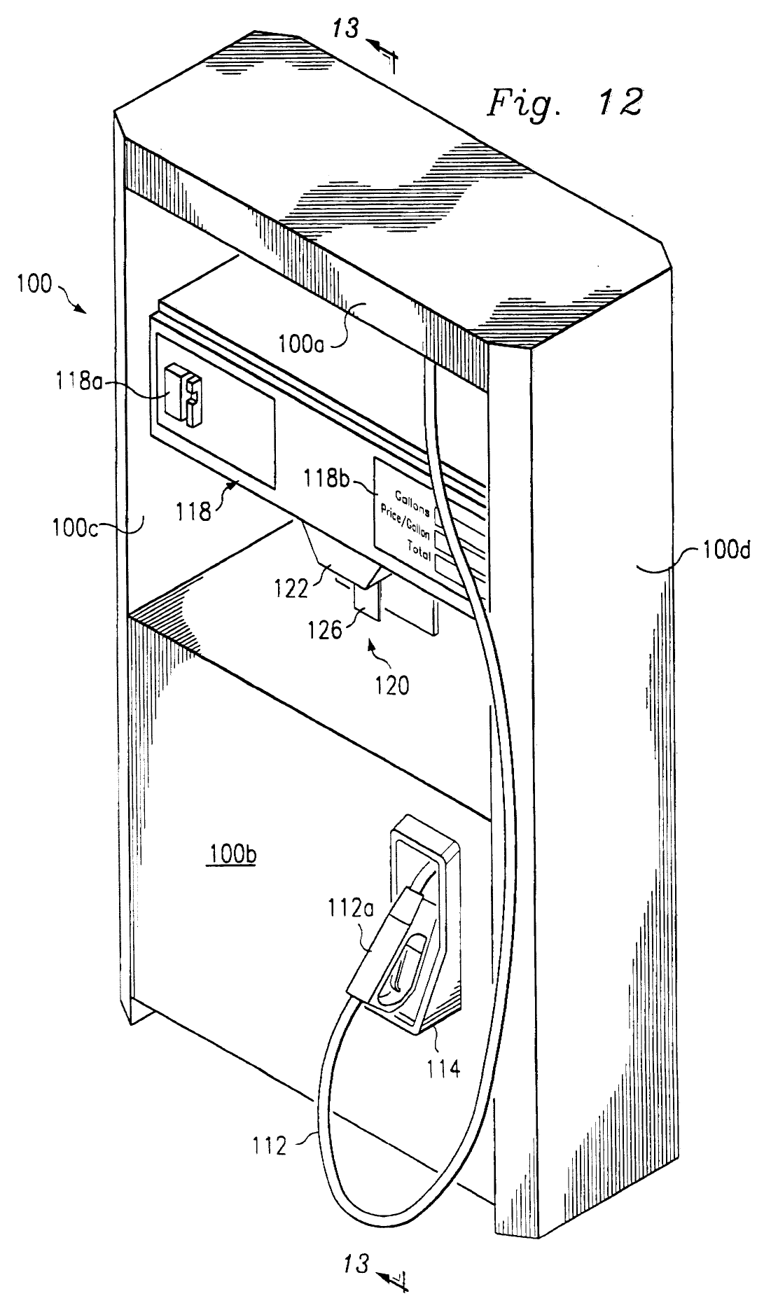

According to the alternate embodiment shown in FIGS. 10 and 11, the printing module 16 of the previous embodiment is replaced by a printing module 58, and the dispensing unit 10 is otherwise the same. The module 58 is located in the same place in the dispenser unit 10 as the printing module 16 and includes a cabinet 60 which includes two opposed end panels, or bezels, 62 and 64 having a slots 62a and 64a respectively extending therethrough. The cabinet 16 is located in the dispenser unit 10 so that the slot 64a faces the front of the unit as shown in FIG. 1.

As shown in FIG. 11, a printing head 66 is mounted in the cabinet 60 and is adapted to receive tape 68 from a roll thereof positioned above the printing head. The printing head 66 is identical to the printing head of the previous embodiment and, as such, has a slot 66a formed therein for receiving the tape 68. The printing head 66 prints information on the tape 68 relating to each transaction involving dispensing gasoline from the dispenser unit 10, as in the previous embodiment. It is understood that the printing head 66 and the roll of tape 68 are mounted to the interior of the cabinet 60 by brackets, plates, or the like, which are not shown for the convenience of presentation, and in a manner to allow the tape 68 to pay out from the roll and into the slot 66a in the printing head.

A subhousing 70 is mounted in the lower portion of the housing 60 and has a slot 70a formed in the upper wall thereof for receiving the tape 68, as well as two additional slots 70b and 70c extending through the respective end walls thereof. Two spaced rollers 72 and 74 are mounted on one end of the subhousing 70 and receive a endless belt 76. Similarly, two additional spaced rollers 78 and 80 are mounted on the other end of the subhousing 70 and receive a endless belt 82. A guide lever 84 is pivotally mounted in the subhousing 70 and is located just inside the slot 70a for selectively guiding the tape passing thought the slot to either the belt 76 or the belt 82 for further advancement through the subhousing, as will be described.

A motor 86 having a drive pulley 86a is disposed in the cabinet 60 externally of the subhousing 70. An endless belt 88 extends around the pulley 86a and the rollers 72 and 78 for driving the rollers and therefore the belts 76 and 82. The motor 86 is adapted to rotate the pulley 86a in a counter-clockwise direction, as viewed in FIG. 11, to drive the roller 72, and therefore the belt 76, in the same direction. The belt 76 is slightly spaced from the corresponding inner surface of the subhousing 70 to define a passage through which the tape passes. Although the height of the latter passage has been exaggerated somewhat for the convenience of presentation it is understood that the design is such that the tape is slightly pressed between the belt 76 and the latter surface so that the belt drives the tape 86 from the slot 70a to the slot 79c. The motor 86 is also adapted to drive the pulley 86a in a clockwise direction to drive the roller 78, and therefore the belt 82, in the same direction and the design is also such that this advances the tape 86 from the slot 70a to the slot 70c.

The slots 70b and 70c are in alignment with the slots 62a and 64a, respectively, of the cabinet 60 so that the tape 68 passes through the latter slots. The tape 86 is advanced in the foregoing manner until a predetermined length of the leading end portion of the tape 86 projects outwardly from the shot 64a as shown in FIG. 11 or from the slot 62a for access by the customer. Two slightly-spaced tear bars 90a and 90b are mounted to the lower end of the printer to either side of the tape 68 and is exits the printer. Therefore, when the customer pulls the projecting section of the tape 68 from the slot 62a or 64a, the leading end section of the tape will be severed from the remaining portion thereof one of the bars 90a and 90b, respectively.

It is understood that the printing head 66, the roll of tape 68, the motor 86 and the guide lever 84 can be activated by a switch associated with the dispenser unit, and deactivated by a timer, another switch, or the like.

In operation, it will be assumed that a customer dispenses gasoline from the front of the dispensing unit 10 as shown in FIG. 1, using the nozzle 12a. Upon completion of the transaction, including the purchase of the gasoline by a credit card or the like, the leading end portion of the tape 68 is passed through the printing head 66 which prints information relating to the transaction. The guide lever 84 is moved to the position shown in FIG. 11 to guide the leading end section of the tape 68 towards the belt 82. The motor 86 is activated to rotate the pulley 86a in a clockwise direction to drive the belt 82 and advance the leading end section of the tape 68 towards and through the subhousing 70 and the aligned slots 70c and 64a until its leading end section projects from the subhousing 70 as shown in FIG. 11. The customer can grasp the projecting section of the tape 68 and pull upwardly so that the tear bar 90 cuts the section, from the remaining portion of the tape 68 which section forms a receipt for the transaction.

Of course, if a customer dispenses gasoline from the end of the dispensing unit where the end panel 62 of the cabinet is exposed, the motor is driven in a counter-clockwise direction and the guide lever 84 is moved to a position to direct the leading end section of the tape 68 toward the belt 76 and therefore the aligned slots 70b and 62a. The latter section is then cut by the tear bar 90b in the same manner as described above.

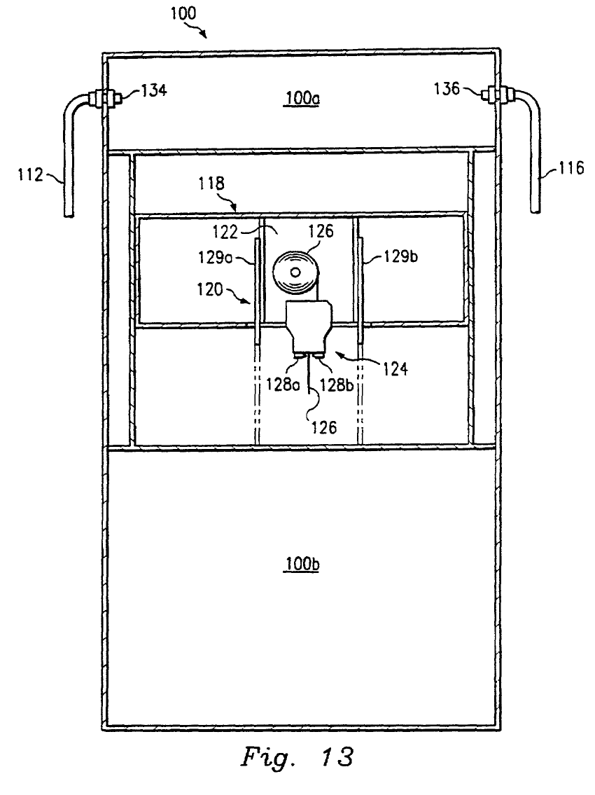

Variations may be made in the embodiment of FIGS. 11 and 12 within the scope of the invention. For example, the tear bars 90 and 92 can be replaced by cutter bars which are adapted to be mechanically actuated to cut the leading end portion of the tape 86 from the remaining portion thereof. Thus, as soon as the leading end section of the tape 86 is printed and passes through the slot 70a and to the belt 76 or 82, it can be severed by the above cutters before its end reaches the slots 62a or 64a and the severed portion advanced towards the latter slots 62a and 64a in the manner described above for access by the customer.

Another embodiment of the present invention is shown in FIGS. 12 and 13 and includes a dispenser unit 100 which is similar to the dispensing unit 10 and, as such has an upper housing 100a and a lower housing 100b connected by two spaced support members 100c and 100d. The lower housing 100b contains hydraulics (not shown) including conduits that are connected to underground storage tanks for gasoline to be dispensed.

A conduit (not shown) extends from the lower housing 100b to the upper housing 100a for passing gasoline to one end of a hose 112 extending from the front of the upper housing 100a. The other end of the hose 112 is connected to a nozzle 112a for dispensing gasoline from the storage tank to a vehicle. A boot 114 is provided on the front panel of the lower housing 100b for receiving the nozzle 112a during nonuse.

Another conduit (not shown) extends from the lower housing 100b to the upper housing 100a for passing gasoline to one end of a hose 116 (FIG. 13) extending from the rear end of the upper housing 110a. It is understood that a nozzle (not shown) is connected to the other end of the hose 116 for dispensing gasoline from the storage tank to a vehicle, and that a boot (not shown) is also provided for receiving it during nonuse.

An electronics housing 118 is provided in the upper housing 100a and contains various electronic components, including a credit card reader 118a and a display 118b which displays certain information relating the purchase of gasoline, as discussed above. The respective fronts of the reader 118a and the display 118b extend through the front panel, or bezel, of the housing 118. Although not shown in the drawing, it is understood that the electronics housing 118 extends to the rear end of the dispensing unit 100 so that customers can be serviced from both the front and the rear of the dispenser unit. Since all of this is conventional, it will not be described in further detail.

As shown in FIG. 13 an printing assembly 120 is mounted in the electronic housing 118 and includes a cabinet 122 which receives a printing head 124 in the lower portion thereof. As shown in FIG. 12, the lower portion of the pringing head 124 projects downwardly from the lower portion of the cabinet 122 and from the housing 118 and in the space between the support members 100c and 100d and between the upper housing 100a and the lower housing 100b.

A roll of tape 126 (FIG. 13) extends over the printing head and since the printing head 124 and the tape 126 are identical to the printing head and the tape of the previous embodiments, they will not be described in detail. It is understood that the cabinet 122 is mounted in the electronics cabinet 118, and the printing head 124 and roll of tape 126 are mounted in the cabinet, by brackets, plates, or the like, which are not shown for the convenience of presentation, and in a manner to allow the tape 126 to pay out from the roll and into the slot in the printing head as discussed above.

Two tear bars 128a and 128b are mounted on the lower end of the printing head 124 to either end of the tape 126 as it exits the head. The tear bars 128a and 128b are adapted to sever the tape 126 when it is pulled towards the bars. Therefore, if a customer dispenses gas from the front of the dispensing unit 100 as shown in FIG. 12, and therefore uses the nozzle 112a, he or she would pull the leading end section of the tape 126 towards the tear bar 128a to sever the tape. Similarly, if the customer dispenses gasoline from the rear end of the dispensing unit, and therefore uses the nozzle 116a, he or she would pull the leading end section of the tape 126 towards the tear bar 128b to sever the tape.

Two shields 129a and 129b are respectively mounted to the end walls of the cabinet 122 and are adapted to move from a retracted position shown by the solid lines to a extended position shown by the dashed lines in FIG. 13. It is understood that this movement of the shields 128a and 129b can be achieved in any conventional manner such as by spring loading them to move to one position and by using a solenoid valve, or the like, (not shown) to move them to their other positions.

In operation, it will be assumed that a customer dispenses gasoline from the nozzle 112a from the front of the dispenser unit 100 as viewed in FIG. 12. Upon completion of the transaction, including the purchase of the gasoline by a credit card or the like, the roll of tape 126 (FIG. 13) is rotated to advance the leading end section of the tape through the printing head 124 which prints information relating to the transaction. The shield 129b is dropped to the shielding position shown by the dashed lines in FIG. 13 to shield the printed section of tape from a customer at the rear end of the dispenser unit 100, and the printed section of tape is advanced through the lower, open end the housing 122 of the printing assembly 120 so as to project from the latter end.

After completing the dispensing of gasoline through the nozzle 138, the customer can grasp the projecting tape section and pull it until the tear bar 128a severs the printed leading end section from the remaining portion of the tape 126 which forms a receipt for the transaction. Of course, if a customer dispenses gasoline from the nozzle 116a on the other end of the dispensing unit 100, the operation is identical to that just described with the exception that the shield 129a is activated and lowered to a shielding position. It is understood that the printing head 124, the roll of tape 126, and the shields 129a and 129b can be activated by a switch associated with the dispenser unit, and deactivated by a timer, another switch, or the like.

According to all three embodiments of the present invention, printing can be achieved for customers dispensing gasoline from both ends of a dispenser utilizing a single printing assembly. To this end, a receipt is dispensed from a single printer serving two customers and is presented to the proper customer while preventing access to the receipt by the other customer. Major advantages are thus achieved with the embodiments of the present invention since the costs, complexity and space requirements of two printing assemblies are eliminated. Also, the embodiments of the present application are relatively simple in construction and durable and can use the bezels, or end panels, of a standard printing assembly with little modification.

It is understood that modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A method for providing receipts for a gasoline dispensing transactions according to which gasoline is dispensed from opposite ends of a dispenser unit, the method comprising the steps of providing a printer in the dispenser unit, printing the receipt at the printer for a transaction occurring at one end of the dispensing unit, providing access to the printed receipt to the customer from the one end of the dispenser unit while preventing access to the latter receipt by a customer from the other end of the dispenser unit.

2. The method of claim 1 further comprising the step of printing a receipt at the printer for a transaction occurring at the other end of the printer using the same printer while preventing access to the receipt by a customer from the one end of the dispensing unit.

3. The method of claim 2 further comprising the step of providing a roll of tape, feeding the tape into the printer for printing information relating to the transactions on the leading end section of the tape, and severing the leading end section of the tape from the remaining portion thereof to form the receipt.

4. The method of claim 3 further comprising the step of directing the leading end section into a carrier and moving the carrier between the ends of the dispenser unit to provide the access.

5. The method of claim 4 wherein the step of severing is effected by the movement of the carrier causing the leading end section of the tape to engage a cutting member.

6. The method of claims 3 further comprising the step of directing the leading end section to a drive assembly which selectively advances the leading end section to the ends of the dispenser to provide the access.

7. The method of claim 6 wherein the step of severing is effected by the advancement of the leading end section of the tape to engage a cutting member.

8. The method of claim 3 further comprising the step of mounting the printer relative to the dispenser unit so that the printer is accessible from both ends of the dispensing unit.

9. The method of claim 8 wherein the step of severing occurs when the customer pulls the leading end section from the printer and over a cutting member to form the receipt.

10. The method of claim 8 comprising the step of responding to a transaction occurring at one end of the dispensing unit and shielding the printed tape section from the customer on the other end of the dispensing unit.

11. A gasoline dispensing system comprising a housing, a hose extending from one end of the housing for receiving gasoline, a hose extending from the other end of the housing for receiving gasoline, a dispensing nozzle disposed at one end of each of the hoses for dispensing the gasoline, a printing assembly mounted in the housing and comprising a printer for printing a receipt for the dispensing of the gasoline from the nozzle at one end of the housing for access by a customer using the latter nozzle, means for preventing access to the receipts printed by the by a customer at the other end of the housing, the printer adapted to print a receipt for the dispensing of the gasoline from the nozzle at the other end of the housing for access by a customer at the other end, and means for preventing access to the latter receipt by a customer at the one end of the housing.

12. The system of claim 11 further comprising a roll of tape which is fed into the printer for printing information relating to the transactions on the leading end section of the tape, and means for severing the leading end section of the tape from the remaining portion thereof to form the receipt.

13. The system of claim 12 wherein the printing assembly further comprises a carrier adapted to receive the leading end section of the tape from the printer and to move in the housing between the ends of the dispenser system to provide the access.

14. The system of claim 13 wherein the severing means is mounted on the printer and the leading end section of the tape is severed by the severing means in response to movement of the carrier.

15. The system of claims 12 further comprising two drive assemblies mounted in the housing and adapted to advance the leading end section of the tape to the respective ends of the housing to provide the access.

16. The system of claim 15 wherein the drive assemblies are in the form of endless belts, and means to drive the belts to advance the tape sections.

17. The system of claim 15 wherein the severing means is mounted on the printer and the leading end section of the tape is severed by the severing means in response to the advancement.

18. The system of claim 12 further comprising means for mounting the printer in the housing so that the printer is accessible from both ends of the dispensing system.

19. The system of claim 17 wherein the severing means is mounted on the printer and the leading end section of the tape is severed by the severing means when the customer pulls the leading end section from the printer and over the severing means.

20. The system of claim 11 wherein the access-preventing means comprising two shields mounted relatively to the printer for movement between a retracted, non-shielding position and an extended shielding position in which it prevents the access.

21. A printing assembly for printing information on a tape, the assembly comprising a stationary printer for receiving the tape and printing information on the tape, a cutter mounted on the printer, and a carrier disposed in proximity to the printer for receiving a section of the tape, the carrier being movable relative to the printer to cause the cutter to cut the end portion of the tape for dispensing by the carrier.

22. The assembly of claim 21 wherein the carrier is movable relative to the printer in two directions for dispensing the tape at two spaced locations.
